(19) United States
(12) Patent Application Publication
(10) Pub. No.: US 2014/0110645 A1
(43) Pub. Date: Apr. 24, 2014

(54) Device For Positioning Or Stabilising A Suspended Load

(71) Applicant: Joseph O'Kane, Livingston (GB)

(72) Inventor: Joseph O'Kane, Livingston (GB)

(21) Appl. No.: 13/998,334

(22) Filed: Oct. 22, 2013

(30) Foreign Application Priority Data
Oct. 23, 2012 (GB) GB 1 218 999.9

(51) Int. Cl. B66C 13/06

(52) U.S. Cl. CPC B66C 13/06
USPC 254/1

(57) ABSTRACT

A tag line device comprising: attachment means for attaching the device to a load which is to be lifted by lifting equipment; and an elongated cord member having a first end connected to the attachment means such that the cord member can extend downwards from the lifted load to an operator, wherein the cord member includes at least a portion which has a resilience in bending such that the cord member is biased towards a straight configuration.

### FIELD OF THE INVENTION

The present invention relates to devices for positioning or stabilizing a load supported by apparatus capable of lifting and moving suspended loads. More particularly, the present invention relates to tag line devices for safely positioning a suspended load attached to a crane hook.

### BACKGROUND OF THE INVENTION

Lifting equipment, such as cranes, is commonly used in a range of industries to lift and move heavy loads. For example, cranes can be found on ship docks and in the construction industry.

During the lifting and moving of heavy loads using lifting equipment, it is standard practice to attach a simple cord to the load to allow an operator at ground level to maneuver the position the load. These cords are commonly referred to as ‘tag lines’. Tag lines themselves do not contribute to supporting loads. However, they must be capable of withstanding tensile loads from the operator pulling on the tag line when altering the position or orientation of the load.

A known disadvantage and danger associated with the use of tag lines is that the tag line can easily become wrapped around an operator, such as his leg. When a load is lowered, this can result in a large amount of slack in the tag line with this simply lying on the ground. Conventional tag lines, such as ropes, will tend to loosely coil, near and around the feet of the operator if the operator is assisting to lower the load. As a result, the tag line can easily become entangled with the operator or with other articles or with other workmen in the vicinity who may accidentally walk over the tag line. When the load is raised, the operator, other articles, or other workmen can also be raised resulting in injury or damage.

Also, it is common for the load to be supported by the lifting equipment such that the load can rotate freely about a vertical axis. However, the rope is non-rotatably connected to the load. Therefore, rotating of the load causes twisting of the rope about its own longitudinal axis which promotes coiling of the portion of the rope lying on the ground.

It is an object of at least one aspect of the present invention to obviate or mitigate at least one or more of the aforementioned problems.

Memory foam was developed in 1966 by NASA for aircraft cushions. It is a polyurethane material with additional chemicals to increase its viscosity and density. Memory foam is pressure-sensitive and moulds quickly to complement the shape of an applied load, returning to its original shape once the load is removed. Since it was developed, it has been used in padding applications, such as for mattresses, pillows, seat cushions and the like.

### SUMMARY OF THE INVENTION

According to the present invention there is provided a tag line device comprising:

attachment means for attaching the device to a load which is to be lifted by lifting equipment; and

an elongated cord member having a first end connected to the attachment means such that the cord member can extend downwards from the lifted load to an operator,

wherein the cord member includes at least a portion which has a resilience in bending such that the cord member is biased towards a straight configuration.

The cord member may comprise a first material. The first material may comprise polyurethane. The first material may comprise a memory foam material.

Alternatively, the first material may comprise a substantially rigid member. The rigid member may be formed from an elastic material. The rigid member may be formed from metal or plastic or an elastomer.

The first member may comprise a core of the cord member. The cord member may comprise a second material. The second material may comprise a sleeve member which encloses the first material. The second material may comprise a webbing material.

The cord member may only comprise the first and second material.

Alternatively, the cord member may include a third member which may comprise a cable, cord, rope, wire, chain, tape, or the like.

The third member may comprise a core of the cord member.

Alternatively, the cord member may comprise a resilient member provided around the core member and which provides the resilience in bending.

The resilient member may comprise a helical or coiled member. Alternatively, the resilient member may comprise the sleeve member when formed from a resilient material.

Substantially the entire cord member may have a resilience in bending. Alternatively, only one or more first portions of the cord member may have a resilience in bending. The cord member may include one or more second portions which are flexible with substantially no resistance. The or each first portion may be provided towards a second end opposite to the first end connected to the attachment means. Alternatively or in addition, the first and second portions may alternative.

The attachment means may comprise any suitable mechanical means. For example, the cord may be attached to a lower surface of the load by being threaded through an opening (e.g. an eyelet) in the lower surface of the load.

The attachment means may comprise an eyelet, hook, clamp or suction cup. The attachment means may be removable from the end of the cord. A range of attachment means may be provided.

The tag line device may include a swivel member which allows rotation of the cord member about its longitudinal axis relative to the attachment means. The swivel member may operatively interpose the attachment means and cord member.

To assist in use the cord member may be coloured, reflective and/or fluorescent.

The elongated cord member may have a second end opposite the first end connected to the attachment means. A loop member may be provided at the second end for attaching a second tag line device.

### BRIEF DESCRIPTION OF THE DRAWINGS

Embodiments of the present invention will now be described, by way of example only, with reference to the accompanying drawing in which:

FIG. 1 is a representation of a known tag line device for positioning a suspended load attached to a crane hook; and

FIG. 2 is a representation of a tag line device according to the invention.

### BRIEF DESCRIPTION

Generally speaking, the present invention resides in the provision of a tag line device for positioning a suspended load attached to apparatus capable of lifting and moving loads.

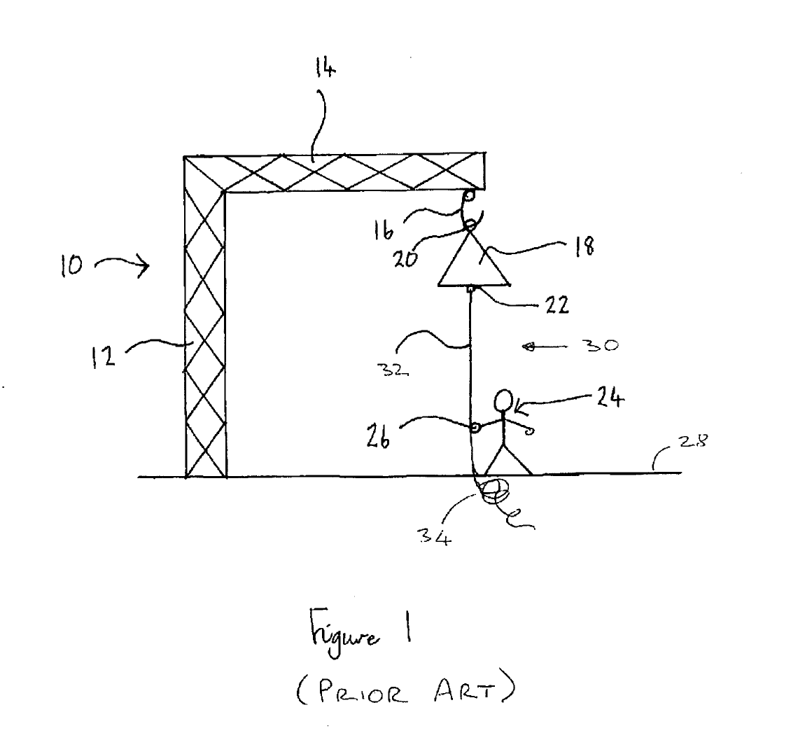

FIG. 1 is a representation of a known tag line device. A crane 10 comprises a substantially vertical member 12 and a substantially horizontal arm member 14. Located at an end of the arm member 14 is a hook 16. The hook 16 is inserted through an opening 20 on top of a load 18 being lifted by the crane 10.

A known tag line device 30 is attached to the load 18 at an attachment point 22. The device 30 includes a rope member 32 which extends downwards by gravity from the load 18 to the ground 28. An operator 24 can be located at the ground 28 to receive the rope member 32 and use the tag line device 30 to position or stabilize the load 18.

The load 18 may have to be lifted to a substantial height and so the rope member 32 of the tag line device 30 must have a correspondingly substantial length. However, this means that, when the load 18 is not being lifted to the maximum height, a portion 34 of the rope member 32 will gather at the ground 28. This portion 34 will tend to coil at a location near the feet of the operator 24 and represents a hazard.

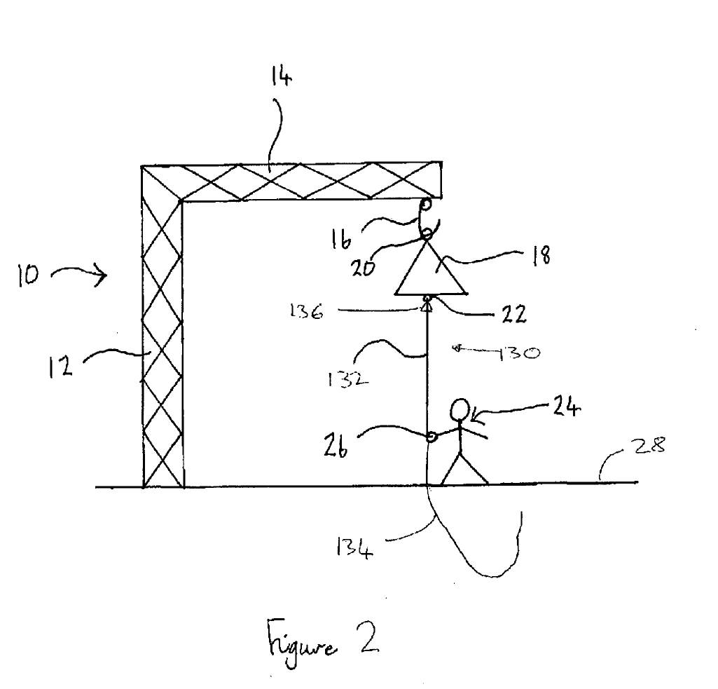

FIG. 2 shows an embodiment of a tag line device 130 according to the invention. Like features are provided with like reference numerals.

As before, the device 130 comprises attachment means 22 for attaching the device 130 to the load 18. An elongated cord member 132 has a first end connected to the attachment means 22 so that the cord member 132 extends downwards from the load 18 to the operator 24. However, the cord member 132 has a resilience in bending such that the cord member is biased towards a straight configuration.

The cord member 132 is formed from a memory foam material which provides the core of the cord member 132. The memory foam material is configured so that, in the absence of any load, the material adopts a straight configuration. Also, any portion of the material which is hanging from the load 18 will experience a load due to gravity which will maintain that portion in the straight configuration.

When the load 18 is not at the maximum height, a portion 134 of the cord member 132 will gather at the ground 28 as before. The vertically extending cord member 132 meeting the horizontal plane of the ground 28 will cause some bending of the cord member 132. The resilience of the material will not necessarily be sufficient to overcome the cord member's mass and frictional contact with the ground to cause the portion 134 to straighten out. However, due to the material used, the portion 134 will not tend to coil around the operator or any other person or article. Therefore, any hazard is eliminated or at least reduced.

It should also be noted that the memory foam material tends to return to its straight configuration at a slow rate (in the order to seconds). Therefore, there is no rapid ‘spring back’ such as can occur with stiff elastic elongated materials, which could itself represent a hazard.

The cord member 132 also comprises a second material. This is provided as a sleeve around the memory foam material core. The second material comprises a webbing material formed from any suitable material such as Nylon or Polypropylene. It is the webbing that will experience and resist the majority of a tensile load applied by the operator 24 pulling on the tag line 130 when altering the position or orientation of the load 18.

It has been found that the tag line device 130 of the invention is at least as strong and durable as known rope tag lines 30 and has a satisfactory flexibility. However, the danger to the operator 24 is significantly reduced.

If desired, the tag line device 130 can be provided with a greater flexibility by varying the properties (or cross sectional area) of the memory foam material. Alternatively, the cord member 132 can be configured to have first portions which are resilient and other portions which are more flexible. The first and second portions could alternate, or only the portion of the cord member 132 which is lower in use may be resilient.

To further inhibit coiling, the tag line device includes a swivel member 136 which allows rotation of the cord member 132 about its longitudinal axis relative to the attachment means 22. This also inhibits coiling of the portion 134 of the cord member 132 which is lying on the ground 28. The swivel member 136 is operatively positioned between the attachment means 22 and the cord member 132.

To assist in use the cord member 132 may be coloured, reflective or fluorescent.

In an alternative embodiment, the cord member may be provided with a loop member at its second end opposite the first end. This allows the attaching of a second tag line device. Two, three or more devices can be attached together to provide the required length for the particular use involved. Therefore, the individual devices can be shorter resulting in less slack lying on the ground.

To reduce any risk associated with the loop member, such as a user inadvertently putting a foot through the loop, the loop member may be biased towards a closed position. This can be achieved by appropriately configuring the memory foam material or the loop member may include a spring mechanism, one or more releasable fasteners or the like.

Whilst specific embodiments of the present invention have been described above, it will be appreciated that departures from the described embodiments may still fall within the scope of the present invention.

1. A tag line device comprising:
attachment means for attaching the device to a load which is to be lifted by lifting equipment; and
an elongated cord member having a first end connected to the attachment means such that the cord member can extend downwards from the lifted load to an operator,
wherein the cord member includes at least a portion which has a resilience in bending such that the cord member is biased towards a straight configuration;
wherein the cord member includes at least a first material and wherein the first material comprises a memory foam material.

2. The device as claimed in claim 1, wherein the first material comprises a core of the cord member.

3. The device as claimed in claim 1, wherein the cord member comprises a second material.

4. The device as claimed in claim 3, wherein the second material comprises a sleeve member which encloses the first material.

5. The device as claimed in claim 3, wherein the second material comprises a webbing material.

6. The device as claimed in claim 3, wherein the cord member comprises only the first and second material.

7. The device as claimed claim 3, wherein the cord member includes a third member which may comprise a cable, cord, rope, wire, chain or tape.

8. The device as claimed in claim 7, wherein the third member comprises a core of the cord member.

9. The device as claimed claim 1, wherein the cord member comprises a resilient member provided around the core member.

10. The device as claimed in claim 9, wherein the resilient member comprises a helical or coiled member.

11. The device as claimed in claim 10, wherein the resilient member comprises the sleeve member when formed from a resilient material.

12. The device as claimed in claim 1, wherein only one or more first portions of the cord member may have a resilience in bending, and the cord member includes one or more second portions which are flexible with substantially no resistance, wherein the first and second portions alternate.

13. The device as claimed in claim 12, wherein the or each first portion is provided towards a second end opposite to the first end connected to the attachment means.

14. The device as claimed in claim 1, including a swivel member which allows rotation of the cord member about its longitudinal axis relative to the attachment means.

15. The device as claimed in claim 14, wherein the swivel member operatively interposes the attachment means and cord member.

16. The device as claimed in claim 1, wherein the cord member is colored, reflective and/or fluorescent.

17. The device as claimed in claim 1, wherein the cord member has a second end opposite the first end connected to the attachment means, and wherein a loop member is provided at the second end for attaching a second tag line device.

18. The device as claimed in claim 17, wherein the loop member may be biased towards a closed position, wherein the loop member includes a spring mechanism.

19. The device as claimed in claim 17, wherein the loop member is formed from a memory foam material which is configured to be closed when in a relaxed state.

20. The device as claimed claim 17, wherein the loop member includes one or more releasable fasteners.
